(19) United States
(12) Patent Application Publication
(10) Pub. No.: US 2019/0037085 A1
(43) Pub. Date: Jan. 31, 2019

(54) IMAGE PROCESSING APPARATUS, IMAGE PROCESSING METHOD AND STORAGE MEDIUM

(71) Applicant: CANON KABUSHIKI KAISHA, Tokyo (JP)

(72) Inventors: Midori Inaba, Tokyo (JP); Masashi Oya, Soka-shi (JP)

(21) Appl. No.: 16/037,421

(22) Filed: Jul. 17, 2018

(30) Foreign Application Priority Data
Jul. 31, 2017 (JP) 2017-147664

(51) Int. Cl. H04N 1/00; H04N 1/60; H04N 9/31

(52) U.S. Cl. CPC H04N 1/00267; H04N 1/6002; H04N 9/3194; H04N 9/3182; H04N 1/6097

(57) ABSTRACT

An image processing apparatus which generates data to be output to a projector in order to superimpose an image displayed by the projector on an image formed on a recording medium by a printer, and which has a first acquisition unit for acquiring image data representing an image to be reproduced, a second acquisition unit for acquiring information for specifying a reflection characteristic of the image to be formed on the recording medium by the printer, and a correction unit for correcting a brightness of color of the image represented by the image data based on the information.

### BACKGROUND

### Field of the Disclosure

The present disclosure relates to an image processing technique for generating one image by combining images output from a plurality of devices.

### Description of the Related Art

In recent years, a technique of emphasizing the glossiness of a metal is used by forming a printed matter by using a metallic ink containing metal powder such as aluminum in the ink. Japanese Patent Laid-Open No. 2010-76317 is known as a technique for forming printed matter using metallic ink and color ink. According to the method described in Japanese Patent Laid-Open No. 2010-76317, by arranging dots of color ink and dots of metallic ink so as not to make the dots overlap each other on the paper surface, color expression by color ink and gloss expression by metallic ink are compatible with each other.

### SUMMARY

In order to emphasize the glossiness of the metal on a recording medium, the region for recording with the metallic ink needs to be enlarged. In this case, if ink recording is made such that the color ink and the metallic ink do not overlap on the paper as described in Japanese Patent Laid-Open No. 2010-76317, the area in which the color ink can be held is limited, and there are cases where desired color expression cannot be performed. On the other hand, if much color ink is used for recording on a recording medium in order to prioritize color expression rather than gloss expression, the area in which metallic ink can be held is limited and the desired gloss expression cannot be achieved in some cases.

The present embodiments have been made to solve the above-described problems, and an object of the present embodiments is to provide image processing to make reproduction of color and reproduction of gloss compatible with each other on an image obtained by superimposing an image formed by an image forming apparatus and an image displayed by an image display apparatus on each other.

In order to solve the above problem, an image processing apparatus according to some of the present embodiments is one which generates data to be output to a projector in order to superimpose an image displayed by the projector on an image formed on a recording medium by a printer, and includes a first acquisition unit for acquiring image data representing an image to be reproduced, a second acquisition unit for acquiring information for specifying a reflection characteristic of the image to be formed on the recording medium by the printer, and a correction unit for correcting a brightness of color of the image represented by the image data based on the information.

Further features of the present embodiments will become apparent from the following description of exemplary embodiments (with reference to the attached drawings).

### BRIEF DESCRIPTION OF THE DRAWINGS

FIG. 1 is a diagram showing a functional configuration of an image processing system.

FIG. 2 is a flowchart showing processing of an image processing apparatus 1.

FIG. 3 is a diagram showing an environment for observing a superimposed image.

FIG. 4 is a conceptual diagram of specular reflection intensity and diffuse reflection intensity.

FIG. 5 is a diagram showing a data flow of processing for generating a recording amount image.

FIGS. 6A and 6B are diagrams showing an example of a specular reflection intensity conversion LUT 1301.

FIG. 7 is a diagram showing a data flow of processing of determining a correction value.

FIGS. 8A and 8B are diagrams showing an example of a brightness correction LUT 1401.

FIG. 9 is a flowchart showing processing for generating a corrected color image.

FIG. 10 is a diagram showing a data flow of processing for generating a corrected color image.

FIGS. 11A and 11B are diagrams showing an example of a chart for LUT creation.

FIG. 12 shows an example of a measurement method used for LUT creation.

FIG. 13 is a diagram showing a functional configuration of an image processing system.

FIG. 14 is a diagram showing a data flow of processing for determining a correction value.

FIGS. 15A and 15B showing an example of a color correction LUT 2401.

FIG. 16 is a diagram showing a hardware configuration of an image processing system.

### DESCRIPTION OF THE EMBODIMENTS

Hereinafter, embodiments of the present disclosure will be described with reference to the drawings. Incidentally, the following embodiments do not necessarily limit the present disclosure. In addition, all combinations of features described in the present embodiments are not necessarily essential to the solution means of the present disclosure. The same components are denoted by the same reference numerals.

### First Embodiment

In the present embodiment, a printed matter formed using a printer equipped with a metallic ink (glossy recording material) and an image (display image) displayed using a projector are superimposed to generate one image (superimposed image).

(Hardware Configuration of the Image Processing System)

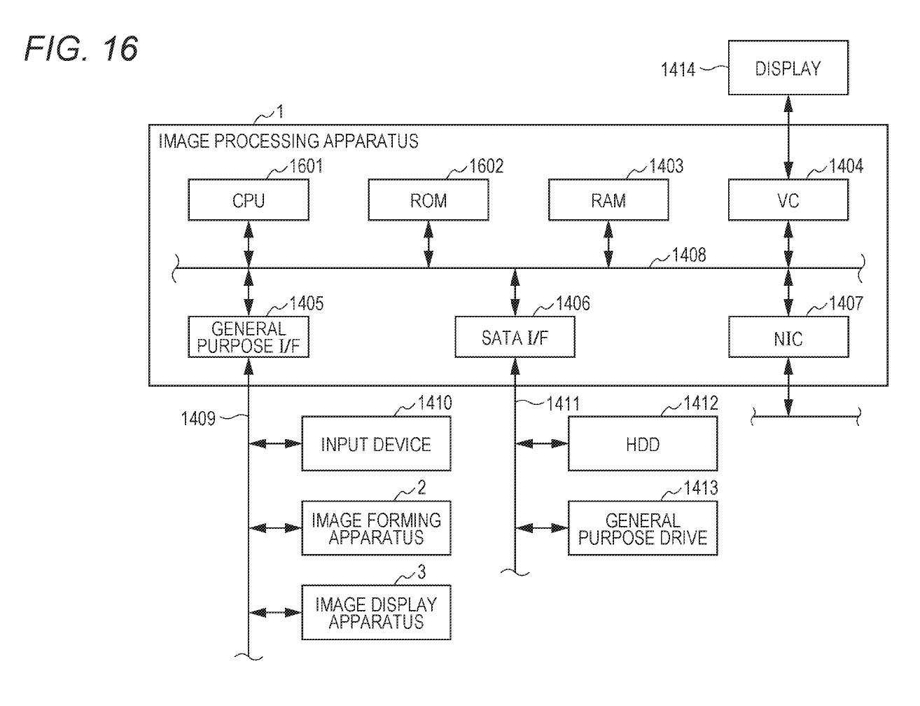

FIG. 16 is a diagram showing an example of the hardware configuration of the image processing system. The image processing system includes an image processing apparatus 1, an image forming apparatus 2, and an image display apparatus 3. The image processing apparatus 1 is, for example, a computer, and includes a CPU 1601, ROM 1602, and RAM 1403. The CPU 1601 executes an operating system (OS) and various programs stored in the ROM 1602, a hard disk drive (HDD) 1412, and the like using the RAM 1403 as a working memory. Further, the CPU 1601 controls each configuration via a system bus 1408. In the processing according to the flowchart to be described later, program codes stored in the ROM 1602, the HDD 1412 or the like are developed in the RAM 1403 and executed by the CPU 1601. A display 1414 is connected to a video card (VC) 1404. An input device 1410, such as a mouse and a keyboard, the image forming apparatus 2, and the image display apparatus 3, are connected to a general purpose interface (I/F) 1405 via a serial bus 1409. The HDD 1412 and a general purpose drive 1413 for reading and writing various recording media are connected to a serial ATA (SATA) I/F 1406 via a serial bus 1411. A network interface card (NIC) 1407 inputs and outputs information to and from an external apparatus. The CPU 1601 uses various recording media mounted on the HDD 1412 and the general purpose drive 1413 as storage locations for various data. The CPU 1601 displays a user interface (UI) screen provided by a program on the display 1414, and receives an input such as a user instruction accepted via the input device 1410.

(Configuration of the Image Forming Apparatus 2)

The image forming apparatus 2 in the present embodiment is an ink jet type printer equipped with metallic ink. An inkjet type printer moves a recording head (not shown) having an ink discharge port relative to a recording medium. Recording is carried out on a recording medium by ink dots whose arrangement has been determined based on input image data when the recording head moves, thereby forming a printed matter. The recording medium in the present embodiment is glossy paper corresponding to printing of metallic ink. Incidentally, the recording medium may be a sheet of paper such as matte paper or plain paper corresponding to metallic ink. The metallic ink is a recording material containing metal flakes. The image forming apparatus 2 according to the present embodiment uses an achromatic silver ink as the metallic ink.

(Configuration of the Image Display Apparatus 3)

The image display apparatus 3 in the present embodiment is a projector having a projection optical unit (not shown). The projection optical unit includes a lamp serving as a light source, a liquid crystal driving device for driving a liquid crystal panel based on input image data, and a projection lens. Light from the lamp is decomposed into red (R), green (G) and blue (B) light by the optical system and guided to the liquid crystal panel. The light guided to each liquid crystal panel and subjected to luminance modulation projects the display image on the printed matter formed by the image forming apparatus 2 via the projection lens.

(Observation Environment of a Superimposed Image)

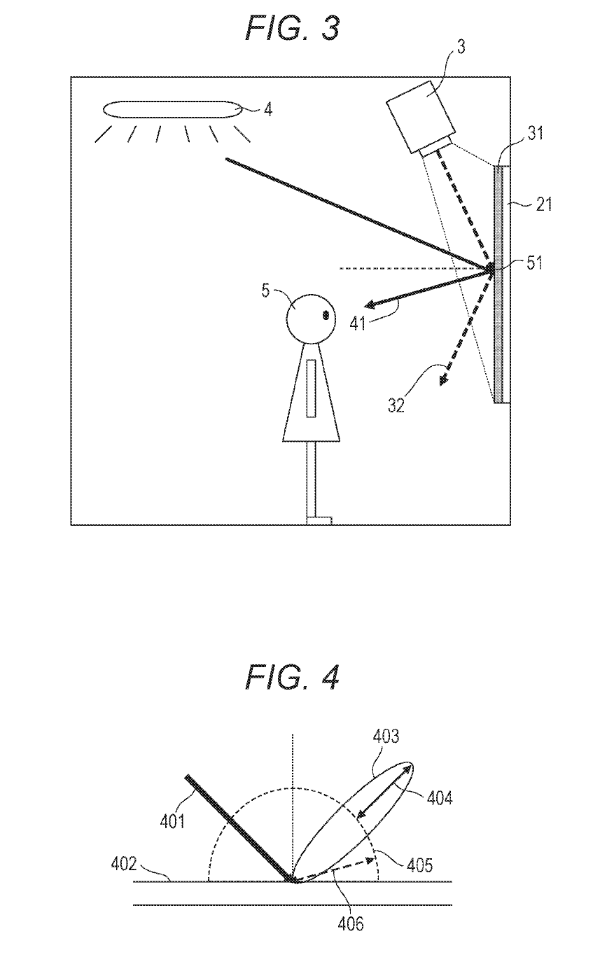

FIG. 3 shows an example of the environment for observing the above-described superimposed image. It is assumed that a printed matter 21 which is formed by the image forming apparatus 2 and on which the metallic ink image is recorded is placed in front of an observer 5 and that a displayed image 31 displayed by the image display apparatus 3 is superimposed on the entire printed matter 21. Also, an ambient light 4 is installed at the upper part of the observation room. The observer 5 visually recognizes the light reflected on the printed matter 21 using the displayed image 31 and the ambient light 4 as light sources. In FIG. 3, a solid line arrow indicates specular reflected light 41 of the ambient light 4 reflected at an observation position 51, and a broken line arrow indicates specular reflected light 32 of the displayed image 31 reflected at the observation position 51. The image display apparatus 3 is installed so that the specular reflected light 32 of the displayed image 31 is not visually recognized by the observer 5 when observing any observation position on the printed matter 21.

(Relationship Between Specular Reflected Light and Diffuse-Reflected Light)

The printed matter on which the metallic ink image is recorded has a surface closer to a mirror surface than a general recording medium (white paper), and tends to reflect light in the specular reflection direction when light is incident. That is, the reflectance of the surface of the printed matter on which the metallic ink image is recorded is high in the specular reflection direction. This reflection characteristic is not limited to the printed matter on which the metallic ink image is recorded, and the same applies to the metallic paper. On the other hand, the diffuse reflection component of the reflected light is small (the reflectance in the non-specular reflection direction is low) on the metallic surface. Accordingly, when a color image output by a projector is superimposed on a printed matter on which recording is made by metallic ink causing less diffuse-reflected light, which is light for perceiving color, there are cases where a desired color cannot be reproduced in a superimposed image. To be specific, a color darker than the desired color (color with low brightness) is visually recognized. Therefore, in the present embodiment, the brightness of the color represented by the color image output by the projector is corrected according to the amount of metallic ink used for recording on the printed matter formed by the printer. To be specific, in the region where the amount of metallic ink is large, since the reflectance in the diffuse reflection direction is low, the brightness of the color represented by the color image output by the projector is increased. Thereby, when the printed matter on which the metallic ink image is recorded and the image output by the projector are superimposed, a desired color in the superimposed image can be reproduced.

(Functional Configuration of the Image Processing System)

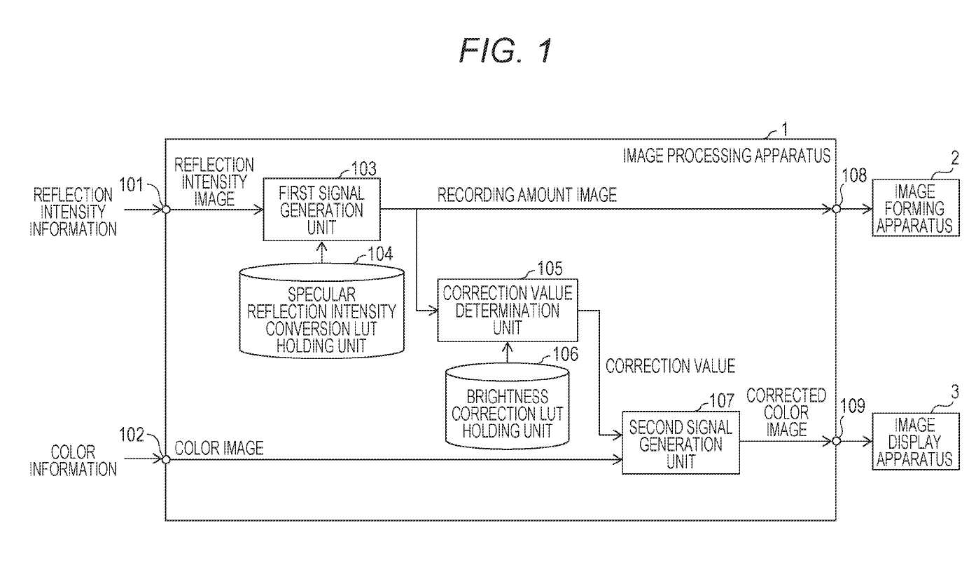

FIG. 1 is a diagram showing an example of a functional configuration of an image processing system. The image processing apparatus 1 includes a first data acquisition unit 101, a second data acquisition unit 102, a first signal generation unit 103, and a specular reflection intensity conversion look-up table (LUT) holding unit 104 (“a first LUT holding unit 104”). Further, the image processing apparatus 1 includes a correction value determination unit 105, a brightness correction LUT holding unit (“a second LUT holding unit 106”), a second signal generation unit 107, a first data output unit 108, and a second data output unit 109. The first data acquisition unit 101 acquires information (gloss information) for specifying reflection characteristics of an image to be formed on the recording medium by the image forming apparatus 2. Here, reflection intensity information representing the intensity of specular reflected light (specular reflection intensity) when light from a light source is incident on the reflecting surface is acquired as the gloss information. The second data acquisition unit 102 acquires color information representing the color of the diffuse-reflected light when the light from the light source is incident on the reflection surface. The acquired reflection intensity information (gloss information) is a gray scale image (hereinafter referred to as reflection intensity image) in which a reflection intensity value (gloss intensity value) represented by 8 bits is recorded in each pixel. In addition, the acquired color information is input image data (hereinafter referred to as a color image) in which color signal values represented by 8 bits are recorded in each pixel. The color signal value is a red (R) value, green (G) value, and blue (B) value recorded in each of the three channels of each pixel of the color image. Note that the color signal values in the present embodiment are RGB values defined in the sRGB space, but may be in other formats, such as the RGB values defined in the Adobe RGB space or L*a*b* values defined in the L*a*b* space. The reflection intensity image and the color image have the same image size and the same resolution. In the present embodiment, it is assumed that the image size is 1200×1200 pixels, and the resolution is 600 dpi. The first data acquisition unit 101 and the second data acquisition unit 102 acquire the information input by the user using the input device 1410 as reflection intensity information and color information. It should be noted that the information may be acquired by reading the reflection intensity information and the color information stored in advance in the storage device, such as the HDD 1412. In this case, the information selected by the instruction input of the user may be acquired from the plural pieces of information stored in the storage device. Details regarding the reflection intensity information and the color information will be described later.

The first signal generation unit 103 generates a recording amount image representing the recording amount of the metallic ink of the image forming apparatus 2, based on the acquired reflection intensity image. The recording amount image is a gray scale image in which a signal value representing the recording amount of metallic ink is recorded in each pixel. The signal value representing the recording amount of the metallic ink is expressed by 8 bits. The recording amount image is generated referring to the specular reflection intensity conversion LUT held in the first LUT holding unit 104. The specular reflection intensity conversion LUT is a table in which specular reflection intensities having values of 0 to 255 and a recording amount of metallic inks having values of 0 to 255 are associated with each other. The number of grid points of the specular reflection intensity conversion LUT is less than 256. When the specular reflection intensity conversion LUT does not hold the recording amount of the metallic ink corresponding to the specular reflection intensity represented by the reflection intensity image, the recording amount of the metallic ink is calculated by the interpolation calculation between the grid points.

The correction value determination unit 105 determines a correction value for correcting the color signal value of each pixel of the color image based on the recording amount image generated by the first signal generation unit 103. The correction value is data representing the value of the decimal point type in each pixel. To be specific, the correction value is data representing a numerical value of 1.0 or more for each pixel of the color image. The pixel value of each pixel of the color image is multiplied by the correction value. Accordingly, the correction value 1.0 indicates that correction is not performed. The maximum value of the correction value is determined by the maximum luminance that can be displayed by the image display apparatus 3. The maximum value of the correction value in the present embodiment is assumed to be 3.5. In determining the correction value, the brightness correction LUT held in the second LUT holding unit 106 is referred to. The brightness correction LUT is a table in which the recording amount of the metallic ink having a value of 0 to 255 is associated with the above-described correction values.

The second signal generation unit 107 corrects the pixel value of each pixel of the color image acquired by the second data acquisition unit 102 by using the correction value obtained by the correction value determination unit 105 and generates output image data in which the corrected pixel value is recorded in each pixel (hereinafter referred to as corrected color image). Similarly to the color image, the corrected color image is a color image in which color signal values represented by 8 bits are recorded in each pixel.

The first data output unit 108 outputs the recording amount image generated by the first signal generation unit 103 to the driver of the image forming apparatus 2. The recording amount image input to the driver is formed on the recording medium as a printed matter of metallic ink after being subjected to halftone processing. In the present embodiment, a dither method known as halftone processing is used. Incidentally, the halftone processing may be one of other halftone processing methods, such as an error diffusion method.

The second data output unit 109 outputs the corrected color image generated by the second signal generation unit 107 to the driver of the image display apparatus (display unit) 3. For the corrected color image input to the driver, the color signal values of each pixel are converted into color signal values in the display color space and are displayed as display images by the light emitting elements of the image display apparatus 3.

(Reflection Intensity Information and Color Information)

Hereinafter, the reflection intensity information and color information acquired by the first data acquisition unit 101 and the second data acquisition unit 102 will be described. The reflection intensity information is a reflection intensity value of light which is incident on the surface to be reproduced and is reflected in the specular reflection direction. FIG. 4 is a diagram schematically showing reflection characteristics when incident light 401 is incident on a reflection surface 402 at an angle of 45 degrees. The light reflected on the reflection surface 402 is divided into two types of light, which are specularly reflected light 403 strongly reflected in the specular reflection direction and diffuse-reflected light 405 reflected in many directions. The intensity of the specular reflected light 403 expressed by a ratio to a reference value is specular reflection intensity 404 and the intensity of the diffuse-reflected light 405 similarly expressed by a ratio to a reference value is diffuse reflection intensity 406. As the reference value, 1.0, which is the diffuse reflection intensity of the perfectly diffuse reflection surface, is used. Incidentally, the diffuse reflection intensity 406 has an intensity value for each of R, G, and B. Therefore, the diffuse reflection intensity 406 for each RGB is called a diffuse reflection color in the present embodiment in order to clarify that the intensity has information for each color.

(Flow of Processing Executed by the Image Processing Apparatus 1)

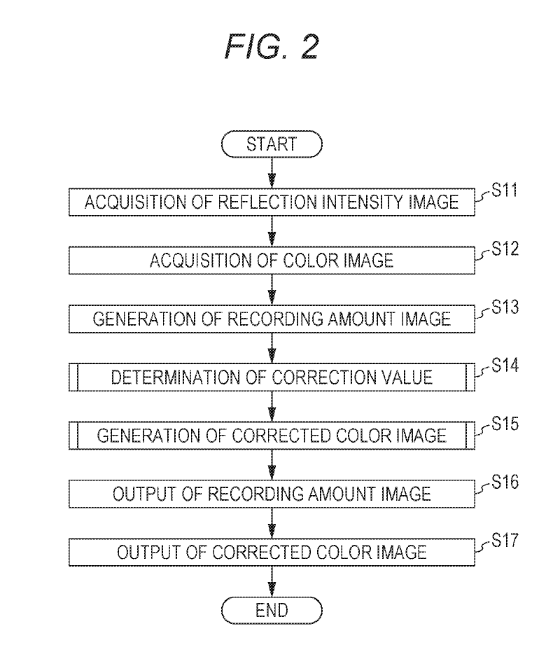

Next, the image processing in the image processing apparatus 1 having the above-described functional configuration will be described with reference to the flowchart of FIG. 2. Hereinafter, each step (process) is represented by attaching S before the code.

First, the first data acquisition unit 101 acquires a reflection intensity image in S11. Next, the second data acquisition unit 102 acquires a color image in S12. Next, the first signal generation unit 103 generates a recording amount image based on the reflection intensity image in S13. In generating the recording amount image, the specular reflection intensity conversion LUT held in the first LUT holding unit 104 is referred to. Details of the processing in S13 will be described later.

Next, the correction value determination unit 105 determines a correction value based on the recording amount image generated by the first signal generation unit 103 in S14. In determining the correction value, the brightness correction LUT held in the second LUT holding unit 106 is referred to. Details of the process in S14 will be described later. Next, the second signal generation unit 107 corrects the pixel value of each pixel of the color image acquired by the second data acquisition unit 102 by using the correction value obtained by the correction value determination unit 105 in S15. Then, a corrected color image in which the corrected pixel value is recorded in each pixel is generated. Details of the processing in S15 will be described later. Next, the first data output unit 108 outputs the recording amount image obtained by the first signal generation unit 103 to the image forming apparatus 2 in S16. Next, the second data output unit 109 outputs the corrected color image obtained by the second signal generation unit 107 to the image display apparatus 3 in S17. This completes a series of image processing.

(Process of Generating a Recording Amount Image (S13))

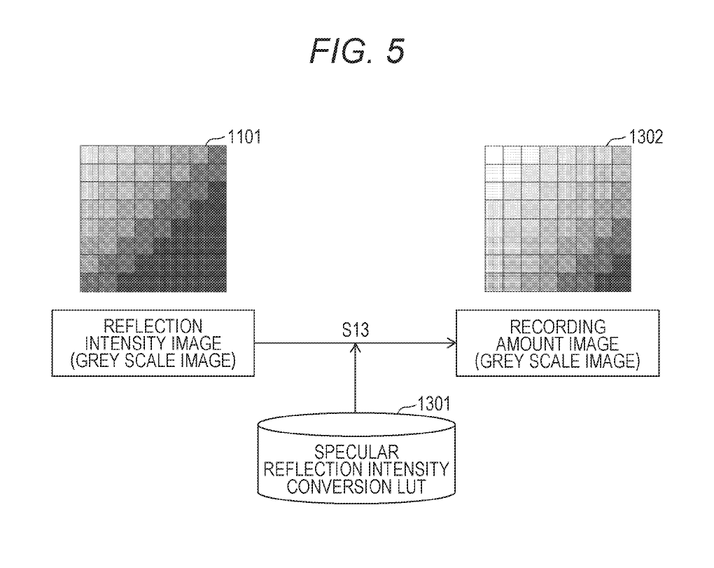

Hereinafter, the generation process of the recording amount image (S13) will be described in detail. FIG. 5 is a diagram showing a data flow in the generation process of the recording amount image. As shown in FIG. 5, the first signal generation unit 103 converts the pixel value of each pixel of an reflection intensity image 1101 acquired by the first data acquisition unit 101 into the signal value of each pixel of a recording amount image 1302 while referring to a specular reflection intensity conversion LUT 1301. The specular reflection intensity conversion LUT 1301 is held in advance in the first LUT holding unit 104.

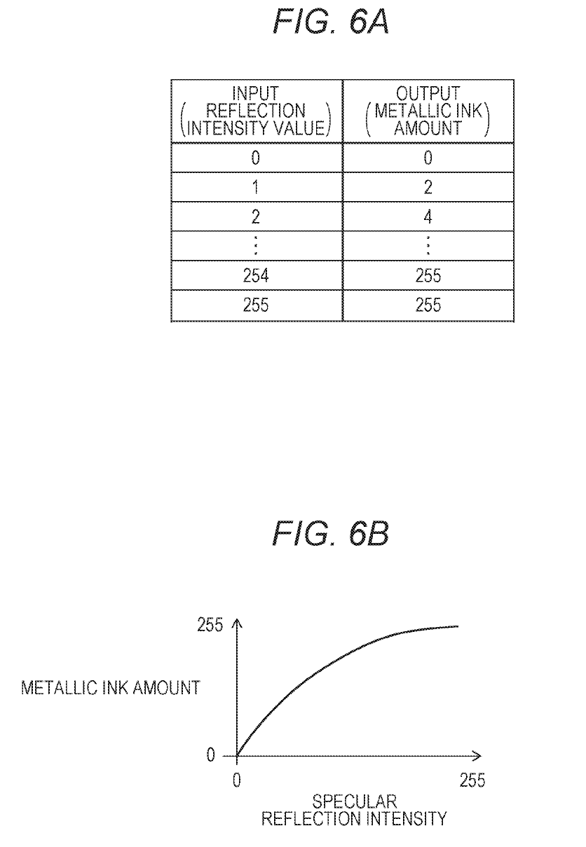

An example of the specular reflection intensity conversion LUT 1301 is shown in FIGS. 6A and 6B. The specular reflection intensity conversion LUT 1301 holds the correspondence relationship between the specular reflection intensity value recorded in each pixel of the specular reflection intensity image and the recording amount of metallic ink recorded in each pixel of the recording amount image. FIG. 6B shows the correspondence relationship in FIG. 6A as a graph. As described above, the correspondence relationship held by the specular reflection intensity conversion LUT 1301 is a relationship in which the recording amount of the metallic ink increases as the specular reflection intensity value increases. To be more specific, the specular reflection intensity in the present example is expressed by the area coverage modulation method using metallic ink. For this reason, when dots of metallic ink are ejected onto the recording medium, the high-density area where a larger number of dots of metallic ink are ejected has a specular reflection intensity higher than that of the low-density area where a smaller number of dots are ejected. The data held in the specular reflection intensity conversion LUT 1301 is created in advance by forming an image on a recording medium using a chart whose amount of metallic ink is known and by measuring the specular reflection intensity value of the formed image. A detailed method of creating the specular reflection intensity conversion LUT 1301 will be described later.

(Process of Determining a Correction Value (S14))

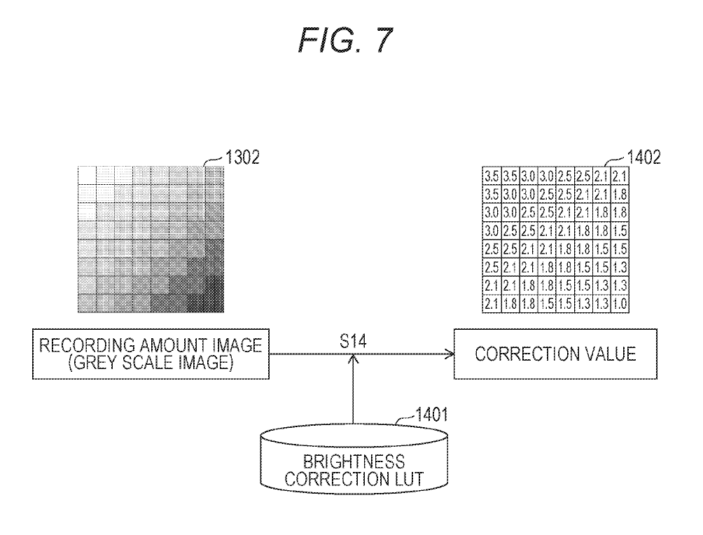

Hereinafter, a determination process of the correction value (S14) will be described. FIG. 7 is a diagram showing a data flow in the correction value determination processing. As shown in FIG. 7, the correction value determination unit 105 refers to a brightness correction LUT 1401 for the pixel value of each pixel of the recording amount image 1302 generated in the generation process of the recording amount image (S13), thereby determining a correction value 1402 corresponding to each pixel. FIG. 7 shows a decimal value of 1.0 or more as a correction value. The brightness correction LUT 1401 is held in advance in the second LUT holding unit 106.

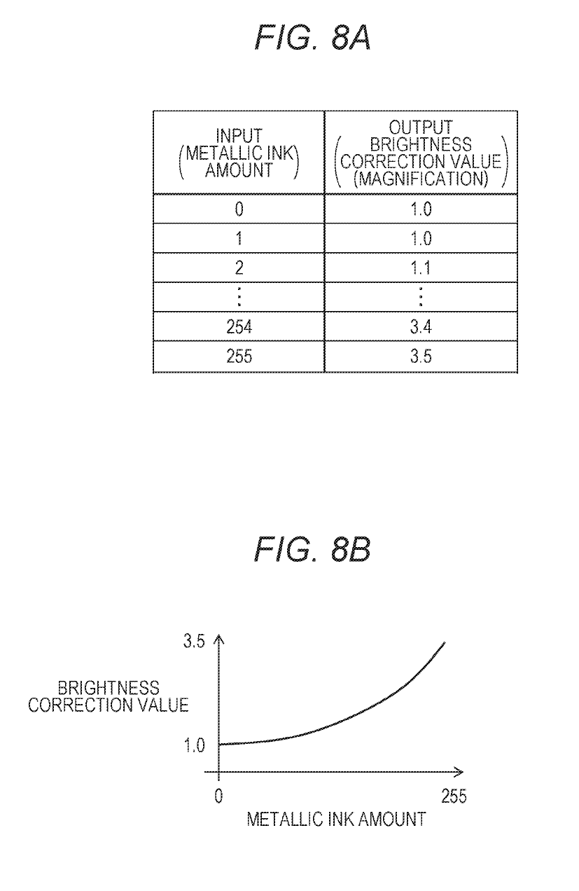

An example of the brightness correction LUT 1401 is shown in FIGS. 8A and 8B. The brightness correction LUT 1401 holds the correspondence relationship between the recording amount of the metallic ink recorded in each pixel of the recording amount image and the brightness correction value recorded as the correction value of each pixel. The brightness correction value is a magnification for multiplying the pixel value of the color image in the process of generating the corrected color image. FIG. 8B is a graph showing the correspondence relationship in FIG. 8A. As shown in FIG. 8B, the correspondence relationship held by the brightness correction LUT 1401 is a relationship in which the brightness correction value (magnification) becomes larger as the recording amount of the metallic ink is greater. The data held in the brightness correction LUT 1401 is prepared in advance by forming an image on a recording medium using a chart whose amount of metallic ink is known and by measuring the diffuse reflection intensity value of the formed image. A detailed creation method of the brightness correction LUT 1401 will be described later.

(Process of Generating a Corrected Color Image (S15))

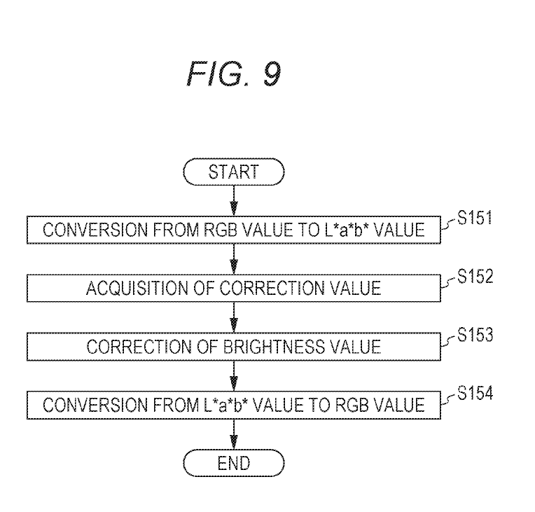

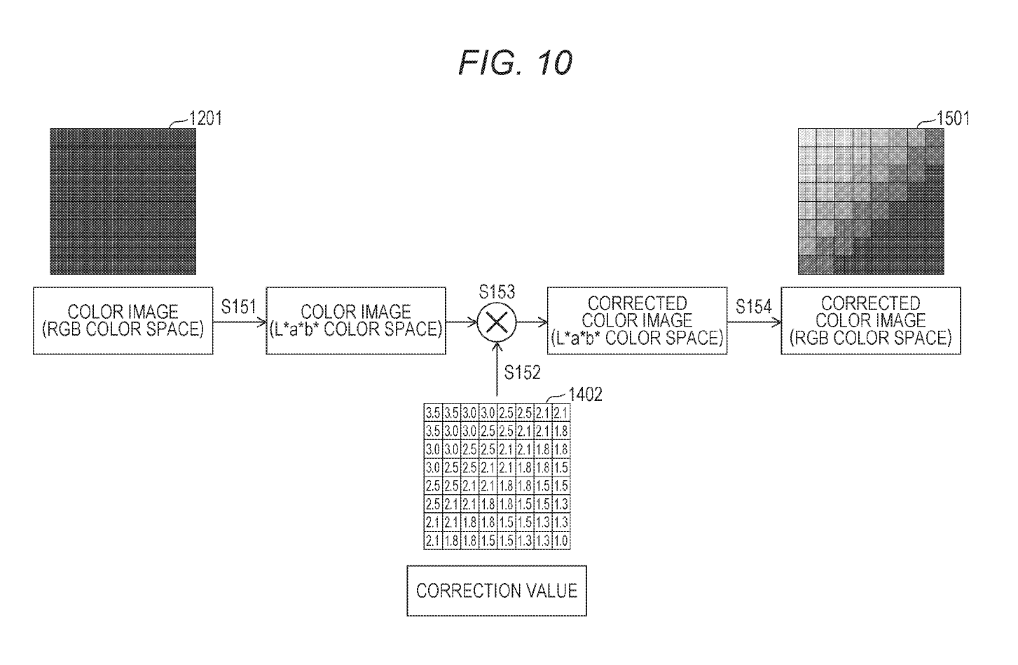

Hereinafter, details of the generation process of the corrected color image (S15) will be described. FIG. 9 shows a flow chart of the generation process of the corrected color image, and the data flow is shown in FIG. 10. First, the second signal generation unit 107 converts the pixel value of each RGB recorded in each pixel of a color image 1201 acquired in S12 to L*a*b* values defined by the L*a*b* color space in step S151. Details of this conversion processing will be described later. Next, in S152, the second signal generation unit 107 obtains the correction value 1402 generated in S14. Next, in S153, the second signal generation unit 107 corrects the brightness value L* out of the L*a*b* values recorded in each pixel of the color image by multiplying the brightness value L* by the correction value, by referring to the correction value of the corresponding pixel. Finally, the second signal generation unit 107 converts the L*a*b* values corrected in S153 into RGB values defined in the sRGB space in S154. As a result, a corrected color image 1501 is generated in which the RGB values obtained in the present step are recorded in each pixel.

(Creation of a Specular Reflection Intensity Conversion LUT and Brightness Correction LUT)

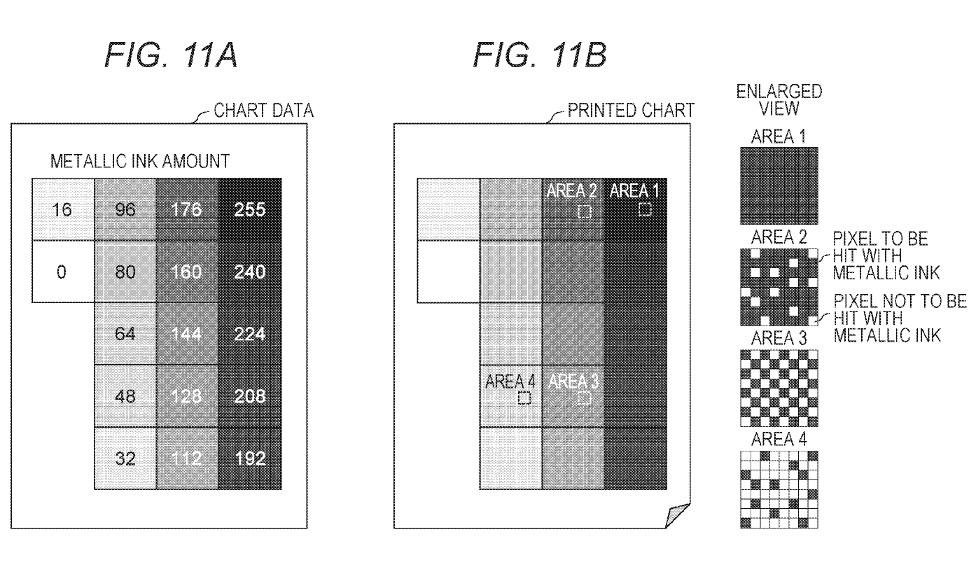

Hereinafter, a method of creating the specular reflection intensity conversion LUT 1301 and the brightness correction LUT 1401 will be described. First, chart data in which the amount of metallic ink is set is created, and an image is formed on the recording medium by using the image forming apparatus 2. An example of the chart data is shown in FIG. 11A, and an example of the chart printed based on the chart data is shown in FIG. 11B. The chart data in FIG. 11A is data representing 17 patch images in which the metallic ink amount is changed from 0 to 255 in increments of 16 (by an increment of 15 at the end). Each patch image is gray scale image data in which the metallic ink amount is recorded in each pixel. It should be noted that the numerical value in each patch image is described for convenience of description in order to indicate the metallic ink amount of each patch image, and is not included as a pattern of an actual patch image. Further, the printed chart of FIG. 11B is a chart formed on the recording medium based on the dot arrangement data obtained by applying the halftone process to the chart data of FIG. 11A. As shown in the enlarged view, each patch included in the chart expresses pixels to be hit with metallic ink in black and expresses pixels not to be hit with metallic ink in white. As the patch image has a larger amount of metallic ink in the chart data, the proportion of the pixels hit with the metallic ink per unit area becomes relatively greater.

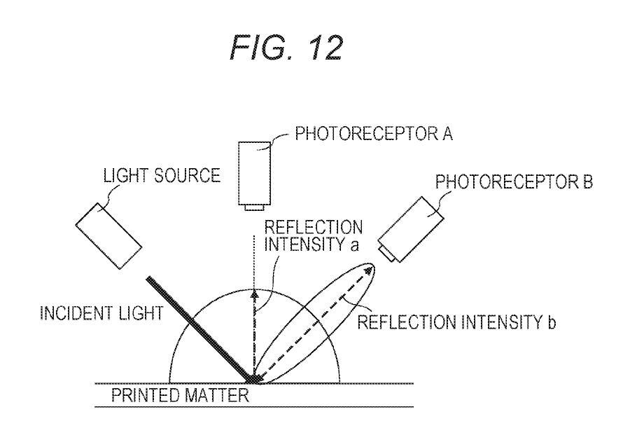

Next, each patch image is measured on a chart formed on the recording medium. The measurement item is the specular reflection intensity for creating the specular reflection intensity conversion LUT 1301 and the brightness of the diffuse reflection color for creating the brightness correction LUT 1401. An example of the configuration of the measuring instruments to be used for the measurement is shown in FIG. 12. In FIG. 12, a light source is arranged at an angle of 45 degrees with respect to the printed matter on which the chart is printed, a photoreceptor A is arranged perpendicularly to the printed matter, and a photoreceptor B is arranged in the specular reflection direction with respect to the incident light from the light source. The photoreceptor A acquires a reflection intensity a, and the photoreceptor B acquires a reflection intensity b. The reflection intensity a is the diffuse reflection intensity (the brightness of the diffuse reflection color), and the value obtained by subtracting the reflection intensity a from the reflection intensity b is the specular reflection intensity.

Next, the specular reflection intensity conversion LUT 1301 is created based on the specular reflection intensity measured using the above measuring instruments. Since correspondence relationship between the metallic ink amount and specular reflection intensity are obtained from a measurement result of each patch image, data conversion is performed for storing the correspondence relationship in the LUT. The method of data conversion is shown below.

First, the specular reflection intensity is normalized and quantized in the range of 0 to 255. Normalization and quantization are performed by known methods. Thereafter, the metallic ink amount corresponding to each specular reflection intensity of 0 to 255 is stored in the specular reflection intensity conversion LUT 1301. At this time, when there is no data of the corresponding metallic ink amount, interpolation is performed using interpolation processing, such as a known linear interpolation method, based on the preceding and succeeding data, and the interpolated value is stored.

Next, the brightness correction LUT 1401 is created using the brightness of the diffuse reflection color obtained by the above measurement. As described above, the brightness correction LUT 1401 keeps the correspondence relationship between the metallic ink amount and the brightness correction value (magnification). The brightness correction value (magnification) is determined employing the following equation (1) using the brightness of the diffuse reflection color. Here, M₀ is the brightness of the diffuse reflection color when the metallic ink amount is zero, and Mₓ is the brightness of the diffuse reflection color when the metallic ink amount is x.

[Expression 1]

Brightness correction value=Mₒ/Mₓ Equation (1)

The corresponding brightness correction value (magnification) is determined using equation (1) while changing x, which is the metallic ink amount, in increments of 1 within the range of 0 to 255, and then stored in the brightness correction LUT 1401.

(Conversion From RGB Values to L*a*b* Values)

The conversion from the RGB values to the L*a*b* values is performed using the following equations (2) to (8).

$$\begin{matrix}[ Expression 2 ] & \\ [ \begin{matrix}X \\ Y \\ Z\end{matrix} ] = [ \begin{matrix}0.4124 & 0.3576 & 0.1805 \\ 0.2126 & 0.7152 & 0.0722 \\ 0.0193 & 0.1192 & 0.9505\end{matrix} ] [ \begin{matrix}R \\ G \\ B\end{matrix} ] & Equation ( 2 ) \\ [ Expression 3 ] & \\ \begin{matrix}Xn = 0.9505 \\ Yn = 1.00000 \\ Zn = 1.0890\end{matrix} \} & Equation ( 3 ) \\ [ Expression 4 ] & \\ \begin{matrix}When X / Xn > 0.00856 \\ XRate = {( X / Xn )}^{1 / 3} \\ When X / Xn \leq 0.00856 \\ XRate = 7.787 \times ( X / Xn ) + 16.0 / 116.0\end{matrix} \} & Equation ( 4 ) \\ [ Expression 5 ] & \\ \begin{matrix}When Y / Yn > 0.00856 \\ YRate = {( Y / Yn )}^{1 / 3} \\ When Y / Yn \leq 0.00856 \\ YRate = 7.787 \times ( Y / Yn ) + 16.0 / 116.0\end{matrix} \} & Equation ( 5 ) \\ [ Expression 6 ] & \\ \begin{matrix}When Z / Zn > 0.00856 \\ ZRate = {( Z / Zn )}^{1 / 3} \\ When Z / Zn \leq 0.00856 \\ ZRate = 7.787 \times ( Z / Zn ) + 16.0 / 116.0\end{matrix} \} & Equation ( 6 ) \\ [ Expression 7 ] & \\ \begin{matrix}When Y / Yn > 0.00856 \\ {L}^{″} = 116.0 \times {( Y / Yn )}^{1 / 3} - 16.0 \\ When Y / Yn \leq 0.00856 \\ {L}^{″} = 903.29 \times ( Y / Yn )\end{matrix} \} & Equation ( 7 ) \\ [ Expression 8 ] & \\ \begin{matrix}{a}^{″} = 500 \times ( XRate - YRate ) \\ {b}^{″} = 200 \times ( YRate - ZRate )\end{matrix} \} & Equation ( 8 )\end{matrix}$$

However, in equation (2), R, G, and B are values in the sRGB space expressed in the range of 0.0 to 1.0, and the calculated X, Y, and Z are tristimulus values expressed by values of 0.0 or more. Also, Xn, Yn, and Zn shown in equation (3) are tristimulus values of the illumination light (D65 light source). The values XRate, YRate, and ZRate in equations (4) to (7) are values indicating the ratio of X, Y, and Z to Xn, Yn, and Zn. The XRate, YRate, and ZRate are finally converted to the value of L* according to equation (7) and converted into the values of a* and b* by equation (8).

(Conversion From L*a*b* Values to RGB Values)

The conversion from the L*a*b* values to the RGB values is performed using the following equation (9) through equation (14). Equations (9) to (14) are equations to be used for inverse transformation of the conversion from the RGB values to the L*a*b* values described in the above equations (2) to (8). Therefore, the description of the same reference numerals as those of equations (2) to (8) will be omitted.

$$\begin{matrix}[ Expression 9 ] & \\ \begin{matrix}When {L}^{″} > 7.99953624 \\ YRate = ( {L}^{″} + 16.0 ) / 116.0 \\ When {L}^{″} \leq 7.99953624 \\ YRate = {( {L}^{″} / 903.29 )}^{1 / 3}\end{matrix} \} & Equation ( 9 ) \\ [ Expression 10 ] & \\ \begin{matrix}XRate = {a}^{″} = 500.0 + YRate \\ ZRate = - {b}^{″} = 200.0 + YRate\end{matrix} \} & Equation ( 10 ) \\ [ Expression 11 ] & \\ \begin{matrix}When {( XRate )}^{3} > 0.008856 \\ X = Xn * {XRate}^{3} \\ When {( XRate )}^{3} \leq 0.008856 \\ X = ( XRate - 16.0 / 116.0 ) * Xn / 7.787\end{matrix} \} & Equation ( 11 ) \\ [ Expression 12 ] & \\ \begin{matrix}When {( YRate )}^{3} > 0.008856 \\ Y = Yn * {YRate}^{3} \\ When {( YRate )}^{3} \leq 0.008856 \\ Y = ( YRate - 16.0 / 116.0 ) * Yn / 7.787\end{matrix} \} & Equation ( 12 ) \\ [ Expression 13 ] & \\ \begin{matrix}When {( ZRate )}^{3} > 0.008856 \\ Z = Zn * {ZRate}^{3} \\ When {( ZRate )}^{3} \leq 0.008856 \\ Z = ( ZRate - 16.0 / 116.0 ) * Zn / 7.787\end{matrix} \} & Equation ( 13 ) \\ [ Expression 14 ] & \\ [ \begin{matrix}R \\ G \\ B\end{matrix} ] = {[ \begin{matrix}0.4124 & 0.3576 & 0.1805 \\ 0.2126 & 0.7152 & 0.0722 \\ 0.0193 & 0.1192 & 0.9505\end{matrix} ]}^{- 1} [ \begin{matrix}X \\ Y \\ Z\end{matrix} ] & Equation ( 14 )\end{matrix}$$

In equations (9) to (13), values calculated from equations (4) to (6) are used for the XRate, YRate, and ZRate respectively.

### Effect of the First Embodiment

As described above, the image processing apparatus 1 acquires color information and gloss information, and generates a signal representing the recording amount of the glossy recording material to be used by the image forming apparatus for recording on the recording medium on the basis of the acquired gloss information. The image processing apparatus 1 determines a correction value for correcting the color information based on the generated signal, and generates color information representing the color of the image displayed by the image display apparatus based on the color information and the correction value. This makes it possible to achieve both color reproduction and gloss reproduction in an image obtained by superimposing the image formed by the image forming apparatus and the image displayed by the image display apparatus.

### Modification Example of the First Embodiment

In the present embodiment, an example in which an inkjet printer is used as the image forming apparatus 2 has been described, but the image formation method is not limited to the above-described example. Any forming method can be employed as long as the apparatus is capable of forming images with different specular reflection intensities on the recording medium in accordance with input image data and is a reflective type allowing the user to observe the reflected light of the image. For example, various recording methods may be used such as an electrophotographic method using a dry toner, a liquid developing method using a liquid toner, or an offset printing method.

In the present embodiment, an example of a silver metallic ink (silver ink) is described as a glossy recording material for forming an image, but the glossy recording material is not limited to the above example. For example, in addition to silver ink, various metal inks, such as gold and copper, can be used. Further, the glossy recording material is not limited to metallic ink, and may be ink having special gloss, such as pearl ink. Also, a high-gloss image may be formed by using clear ink as the glossy recording material and by smoothing the surface.

In the present embodiment, glossy paper is used as a recording medium and metallic ink is used as a glossy recording material, but a recording medium and the glossy recording material are not limited to the above examples as long as a combination of the glossy recording material and the recording medium is capable of expressing a difference in specular reflection intensity. For example, a method of forming an image by using a white ink or a color ink which is a non-metallic ink on silver metallic paper may be used. In this case, the difference in specular reflection intensity is expressed by how large the surface of the metallic paper coated with the nonmetallic ink is. In other words, the difference in specular reflection intensity is expressed depending on the extent of exposure of metallic paper. As the metallic paper, for example, a recording medium formed by vapor deposition of aluminum on a flat recording medium can be used.

Further, in the present embodiment, an example of a projector has been described as the image display apparatus 3, but the image display apparatus 3 is not limited to the above example. The image display apparatus 3 can be used as long as the apparatus is a light emitting type device that generates an image using light emission, and thus a display may be used, for example. In this case, the printed matter of the metallic ink to be superimposed is obtained by forming an image on a transparent recording medium, and the display is placed on the back side of the printed matter. In this case, the display 1414 in FIG. 16 may be used as the image display apparatus 3. The projector is an image display apparatus that displays an image on a printed matter by projecting light, and the display is an image display apparatus that displays an image on a screen by emitting light.

Further, in the present embodiment, the reflection intensity information is expressed by the ratio to the reflection intensity of the perfectly diffuse reflection surface, but is not limited to the above example. It suffices if the specular reflection intensity can be represented relatively by using a predetermined numerical value as a reference, and, for example, the reflection intensity on the total reflection surface of glass or the like may be used as the reference value, or the user may set freely a gloss value as the reference value. In addition, the gloss information may directly indicate the recording amount of the glossy recording material as information for specifying the area where the glossy recording material is used in the image.

In the present embodiment, the reflection intensity information indicating the reflection intensity is used as the gloss information indicating the gloss intensity, but the reflectance information indicating the reflectance which is the ratio between the intensity of the incident light and the intensity of the reflected light may be used. Further, the information may be luminance information representing a luminance value calculated from color information (RGB values).

In the present embodiment, the color information is expressed by RGB values, but the color information is not limited to the above example. For example, the color information may be color information expressed in another color space, such as CMYK values or spectral reflectance data.

In the present embodiment, examples of the brightness correction are described in S14 and S15, but brightness correction is not limited to the above example. It suffices if information on diffuse reflection color can be corrected, and for example, the brightness correction may be a correction performed on luminance or brightness that is expressed in another color space, or a correction performed on spectral reflectance data.

In the present embodiment, the brightness correction LUT having the information of the brightness correction value (magnification) is used in S14, but the determination processing of the correction value is not limited to the above example. For example, a correction value may be calculated by numerical calculation from the recording amount of the metallic ink. In this case, an equation is used whose calculation results in a larger value as the correction value, as the recording amount of the metallic ink increases.

In the present embodiment, the correction value is determined for all the pixels of the color image and the pixel values are corrected. However, the above correction processing may be applied to a partial area of the color image. For example, mask data may be generated based on an instruction input by the user via the UI screen, and whether the area is to be subjected to correction processing may be determined based on the mask data for distinction.

In the present embodiment, examples are described so that the image processing apparatus 1 and the image forming apparatus 2 are connected to each other, and the image processing apparatus 1 and the image display apparatus 3 are connected to each other, but the system configuration is not limited to the above example. For example, the image processing apparatus 1 may be included in the image forming apparatus 2 or the image display apparatus 3.

In the present embodiment, the recording amount image in which the signal value representing the recording amount is recorded in each pixel is output to the image forming apparatus 2, and the halftone processing is performed in the image forming apparatus 2, but the method of forming the image is not limited to the above example. For example, halftone processing may be performed on the recording amount image in the image processing apparatus 1, and the generated dot arrangement data may be output to the image forming apparatus 2. Further, data representing the dot arrangement for each recording scan may be generated by performing path decomposition in the image processing apparatus, and the generated data may be output to the image forming apparatus 2.

Further, in the present embodiment, the corrected color image is generated by correcting the color image, but the corrected color image can also be generated as new image data based on the color image and the correction value.

Further, in the present embodiment, an example in which the correction value increases as the recording amount of the metallic ink increases is shown, but the correction value is not limited thereto. For example, whether the region is one for recording metallic ink is determined, and for the region where metallic ink is to be recorded, the correction value may be set to 1.5, and for the region where metallic ink is not to be recorded, the correction value may be set to 1.0. Further, this determination may be made by determining whether the specular reflection intensity is higher than a predetermined specular reflection intensity which has been determined in advance. In this case, for example, the correction value is set to 1.5 for a region where the specular reflection intensity is higher than the predetermined specular reflection intensity, and the correction value is set to 1.0 for the region where the specular reflection intensity is lower than the predetermined specular reflection intensity.

Further, in the present embodiment, the correction value is determined from the recording amount of the metallic ink determined based on the gloss information, but the method of determining the correction value is not limited to this. The correction value may be determined based on the acquired gloss information without determining the recording amount of the metallic ink. In this case, for example, the correction value is determined by using a table that keeps a relationship in which the correction value increases as the diffuse reflection intensity of the image formed on the recording medium decreases. Further, the correction value may be determined using a table that holds a relationship in which the correction value increases as the specular reflection intensity of the image formed on the recording medium increases.

In the present embodiment, the processing flow of the image processing apparatus 1 has been described using the flowchart of FIG. 2, but the order of the processes is not limited to the above example. For example, the acquisition of the reflection intensity image in S11 and the acquisition of the color image in S12 may be executed in reverse order or executed in parallel.

### Second Embodiment

In the first embodiment, the correction value for the brightness of the color image is determined, and the brightness of the diffuse reflection color corresponding to the recording amount of the silver ink is corrected. On the other hand, when a chromatic color ink, such as gold ink, is used as the metallic ink, not only the brightness but also the chromaticity (hue and saturation) may change as the metallic ink amount increases. Therefore, in the present embodiment, an example will be described in which gold ink is used as the metallic ink used for forming in the image forming apparatus 2, and not only brightness but also chromaticity is corrected in the color image, and the color is more faithfully reproduced.

(Functional Configuration of the Image Processing System)

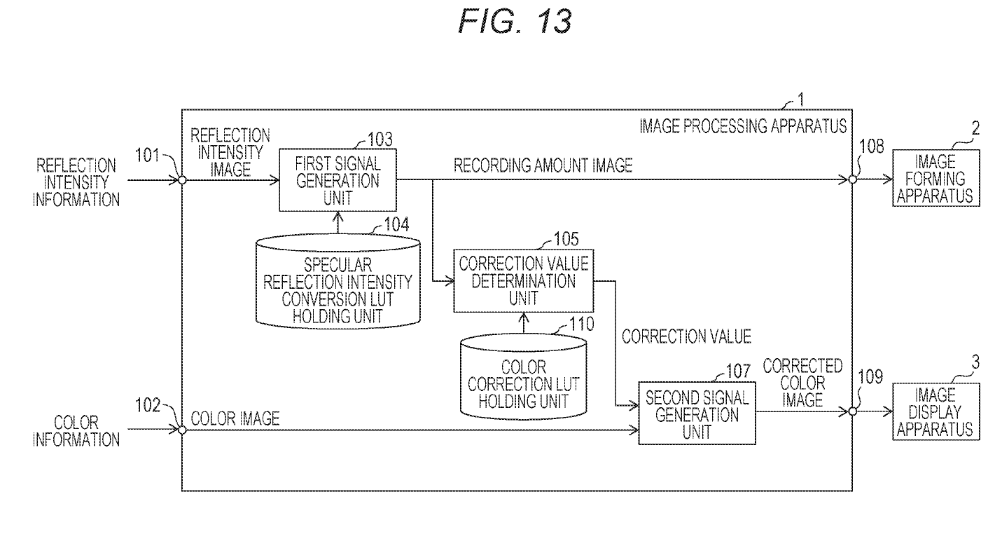

FIG. 13 shows the functional configuration of the image processing system in the second embodiment. In FIG. 13, the difference from the first embodiment is that the brightness correction LUT holding unit 106 is changed to a color correction LUT holding unit 110. Since the other configuration is the same as that of the first embodiment, description thereof is omitted.

(Flow of Processing Executed by the Image Processing Apparatus 1)

In the second embodiment, steps different from those in the first embodiment are processing in the correction value determination step (S14) and processing in the corrected color image generation step (S15). The correction value determination step and the corrected color image generation step in the second embodiment will be described below.

(Process of Determining a Correction Value (S14))

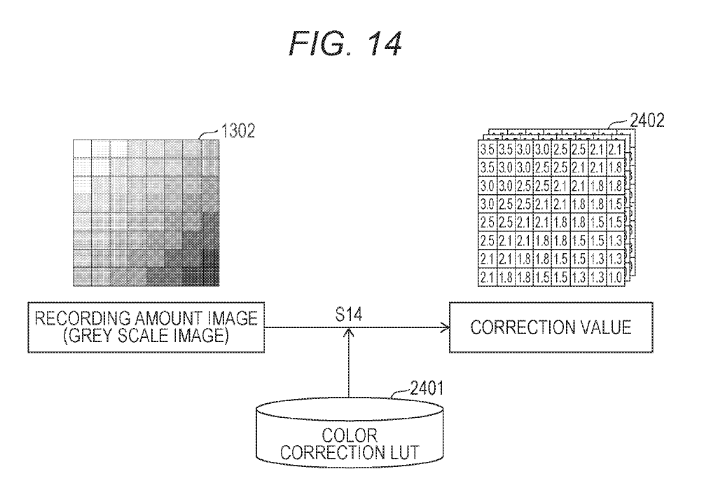

Hereinafter, the determination process for correction values in the present embodiment will be described. The data flow in S14 is shown in FIG. 14. The difference from the first embodiment is that the LUT to be referred to in determining the correction value is a color correction LUT 2401 and that the correction value is determined for not only brightness but also chromaticity (hue and saturation).

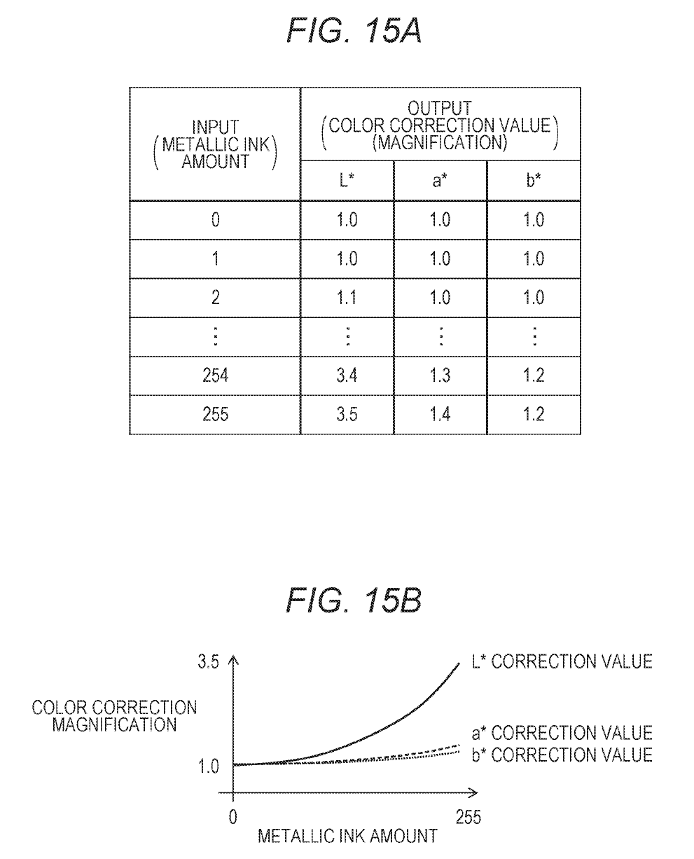

An example of the color correction LUT 2401 is shown in FIGS. 15A and 15B. As shown in FIG. 15A, the color correction LUT 2401 maintains the correspondence relationship between the metallic ink amount recorded in each pixel of the recording amount image and the color correction value (magnification) recorded as the correction value of each pixel. The color correction value represents the correction magnification for each component of the L*a*b* color space.

FIG. 15B is a graph showing the correspondence relationship of FIG. 15A. In this way, the color correction LUT 2401 maintains the relationship in which the color correction value of each color component increases as the amount of metallic ink increases. This is because not only changes in brightness but also changes in chromaticity occur as the recording amount of metallic ink to be used for recording on the recording medium increases.

An image on the recording medium is formed using a chart whose amount of metallic ink is known, and the data to be stored in the color correction LUT 2401 is generated in advance from measured values of the formed image similarly to the brightness correction LUT 1401. At this time, in the first embodiment, only the brightness of the diffuse reflection color is measured, but in the present embodiment, the values of the respective color components are measured and stored in the LUT.

(Process of Generating a Corrected Color Image (S15))

In the first embodiment, the process of generating the corrected color image has already been described using the flowchart in FIG. 9. In S153 of the present embodiment, the second signal generation unit 107 corrects not only the brightness but also the chromaticity (hue and saturation). The other steps are the same as those in the first embodiment, so the description is omitted.

In S153, the second signal generation unit 107 refers to correction values corresponding to the L* value, the a* value, and the b* value for each pixel value of the color image expressed in the L*a*b* color space and corrects the color by multiplying these values by the correction values respectively. At this time, the L* value of the color image is multiplied by a correction value of the L* value, the a* value is multiplied by a correction value of the a* value, and the b* value is multiplied by a correction value of the b* value.

### Effect of the Second Embodiment

As described above, the image processing apparatus 1 corrects not only the brightness of the color signal but also the chromaticity thereof by using the correction value determined according to the recording amount of the glossy recording material. Thereby, even when the chromaticity of the image formed by the image forming apparatus changes in accordance with an increase in the recording amount of the glossy recording material, both color reproduction and gloss reproduction can be achieved together in the above superimposed image.

### Modification Example in the Second Embodiment

In the present embodiment, an example in which color correction is performed in the L*a*b* color space is described in S14 and S15, but color correction is not limited to the above example. For example, the color correction may be correction in another color space, such as an RGB or a CMYK space, or be correction performed on spectral reflectance data. In this case, it is sufficient to prepare correction values for the number of dimensions according to the number of dimensions of the color space.

Further, in the present embodiment, the color correction LUT having the information on the color correction value (magnification) is used in S14, but the determination process of the correction value is not limited to the above example. For example, a method of calculating a color correction value by numerical calculation based on the metallic ink amount may be used.

According to the present embodiment, in an image obtained by superimposing an image formed by an image forming apparatus and an image displayed by an image display apparatus, reproduction of color and reproduction of gloss can be compatible with each other.

### Other Embodiments

Other embodiments can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., a central processing unit (CPU), a micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has described exemplary embodiments, it is to be understood that the claims are not limited to the disclosed exemplary embodiments. The scope of the following claims is to be accorded the broadest interpretation so as to encompass all such modifications and equivalent structures and functions.

This application claims the benefit of Japanese Patent Application No. 2017-147664, which was filed on Jul. 31, 2017 and which is hereby incorporated by reference herein in its entirety.

What is claimed is:

1. An image processing apparatus for generating data to be output to a projector so as to superimpose an image displayed by the projector on an image formed on a recording medium by a printer, the image processing apparatus comprising:
a first acquisition unit configured to acquire image data representing an image to be reproduced;
a second acquisition unit configured to acquire information for specifying a reflection characteristic of the image to be formed on the recording medium by the printer; and
a correction unit configured to correct a brightness of color of the image represented by the image data based on the information.

2. The image processing apparatus according to claim 1, wherein the second acquisition unit acquires information for specifying an area in which a glossy recording material is used in the image to be formed on the recording medium by the printer.

3. The image processing apparatus according to claim 1, wherein the information represents a reflection intensity of the image to be formed on the recording medium by the printer.

4. The image processing apparatus according to claim 1, wherein the information represents a recording amount of a recording material for forming the image on the recording medium by the printer.

5. The image processing apparatus according to claim 2, wherein the information represents a recording amount of the glossy recording material.

6. The image processing apparatus according to claim 1, further comprising a determination unit configured to determine a correction value for correcting the brightness of the color of the image based on the information,
wherein the correction unit corrects the brightness of the color of the image based on the correction value.

7. The image processing apparatus according to claim 6, wherein the correction value becomes larger as a diffuse reflection intensity of the image to be formed on the recording medium by the printer becomes lower.

8. The image processing apparatus according to claim 6, wherein the correction unit corrects the brightness of the color of the image by multiplying a color signal value of the image data by the correction value.

9. The image processing apparatus according to claim 6, wherein the determination unit determines whether a specular reflection intensity of the image to be formed on the recording medium by the printer is higher than a predetermined specular reflection intensity based on the information, and determines the correction value based on a result of the determination.

10. The image processing apparatus according to claim 6, further comprising a holding unit configured to hold a table in which the information and the correction value are associated with each other,
wherein the determination unit determines the correction value based on the table.

11. The image processing apparatus according to claim 1, wherein the correction unit further corrects chromaticity of the color of the image.

12. The image processing apparatus according to claim 11, further comprising a determination unit configured to determine a correction value for correcting the brightness and the chromaticity of the color of the image based on the information,
wherein the correction unit corrects the brightness and the chromaticity of the color of the image based on the correction value.

13. The image processing apparatus according to claim 2, wherein the glossy recording material is a metallic ink.

14. The image processing apparatus according to claim 13, wherein the glossy recording material is an achromatic metallic ink.

15. The image processing apparatus according to claim 13, wherein the glossy recording material is a chromatic metallic ink.

16. The image processing apparatus according to claim 6, wherein
the brightness of the color of the image represented by the image data is indicated by an L* value defined in an L*a*b* color space, and
the determination unit determines the correction value by which the L* value is to be multiplied.

17. The image processing apparatus according to claim 12, wherein
the color of the image represented by the image data is indicated by an L* value, an a* value, and a b* value defined in an L*a*b* color space, and
the determination unit determines the correction value by which the L* value is to be multiplied so as to correct the brightness of the color of the image, the correction value by which the a* value is to be multiplied so as to correct the chromaticity of the color of the image, and the correction value by which the b* value is to be multiplied so as to correct the chromaticity of the color of the image.

18. The image processing apparatus according to claim 1, further comprising an output unit configured to output the image data representing the image whose color brightness has been corrected by the correction unit to the projector.

19. An image processing method for generating data to be output to a projector so as to superimpose an image displayed by the projector on an image formed on a recording medium by a printer, the method comprising:
acquiring image data representing an image to be reproduced;
acquiring information for specifying a reflection characteristic of the image to be formed on the recording medium by the printer; and
correcting a brightness of color of the image represented by the image data based on the information.

20. A non-transitory computer-readable storage medium storing instructions that, when executed by a computer, cause the computer to perform an image processing method for generating data to be output to a projector so as to superimpose an image displayed by the projector on an image formed on a recording medium by a printer, the method comprising:
acquiring image data representing an image to be reproduced;
acquiring information for specifying a reflection characteristic of the image to be formed on the recording medium by the printer; and
correcting a brightness of color of the image represented by the image data based on the information.
